(19) United States
(12) Patent Application Publication
(10) Pub. No.: US 2019/0268776 A1
(43) Pub. Date: Aug. 29, 2019

(54) SYSTEM AND METHOD FOR SPATIAL REUSE

(71) Applicant: QUALCOMM Incorporated, San Diego, CA (US)

(72) Inventors: Alecsander Petru EITAN, Haifa (IL); Amichai SANDEROVICH, Atlit (IL); Assaf Yaakov KASHER, Haifa (IL)

(21) Appl. No.: 16/286,189

(22) Filed: Feb. 26, 2019

Related U.S. Application Data
(60) Provisional application No. 62/635,743, filed on Feb. 27, 2018.

(51) Int. Cl. H04W 16/10; H04L 1/00; H04W 16/28

(52) U.S. Cl. CPC H04W 16/10; H04W 16/28; H04L 1/0003; H04L 1/0083

(57) ABSTRACT

Certain aspects of the present disclosure generally relate to wireless communications and, more particularly, to methods and apparatus for reducing interference from neighboring wireless devices. An exemplary apparatus generally includes a processing system configured to determine an interference sensitivity factor (ISF) based at least in part on one or more interference-related parameters, and generate at least one frame to be output for transmission to a first wireless node via a first link, said at least one frame including the ISF. The apparatus also includes an interface configured to output the at least one frame for transmission to the first wireless node via the first link.

### CROSS-REFERENCE TO RELATED APPLICATION & PRIORITY CLAIM

The present application for patent claims priority to U.S. Provisional Application No. 62/635,743, filed Feb. 27, 2018, which is assigned to the assignee of the present application and hereby expressly incorporated by reference herein in its entirety.

### FIELD

This disclosure relates generally to wireless communications, and in particular, to a system and method for reducing interference from neighboring wireless devices.

### BACKGROUND

A communication system often includes wireless devices configured to communicate with each other at various times. For instance, a first wireless device may participate in a communication session with a second wireless device. During this communication session, a third wireless device may desire to communicate with a fourth wireless device. If the third wireless device is sufficiently close to the first wireless device and/or the second wireless device, a transmission of a signal by the third wireless device intended for the fourth wireless device may produce interference at the first wireless device and/or the second wireless device. The interference may significantly impact the communication session between the first and second wireless devices.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure provide an apparatus for wireless communications. The apparatus generally includes a processing system configured to determine an interference sensitivity factor (ISF) based at least in part on one or more interference-related parameters, and generate at least one frame to be output for transmission to a first wireless node via a first link, said at least one frame including the ISF. The apparatus also includes an interface configured to output the at least one frame for transmission to the first wireless node via the first link.

Certain aspects of the present disclosure provide an apparatus for wireless communications. The apparatus generally includes an interface configured to obtain at least one frame from a first wireless node that is communicating with a second wireless node on a medium via a first link. The apparatus also includes a processing system configured to estimate a potential level of interference, at the first wireless node due to transmissions from the apparatus to a third wireless node on a second link on the medium, based on information in the at least one frame, and reuse the medium for communicating with the third wireless node via the second link if the potential level of interference is equal to or less than a threshold.

Aspects generally include methods, apparatus, systems, computer readable mediums, and processing systems, as substantially described herein with reference to and as illustrated by the accompanying drawings.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates a block diagram of an exemplary wireless communication system in accordance with an aspect of the present disclosure.

FIG. 2 illustrates a block diagram of an exemplary access point and user terminal in accordance with another aspect of the present disclosure.

FIG. 3 illustrates a diagram of an exemplary modified Request to Send (RTS) frame in accordance with another aspect of the present disclosure.

FIG. 4 illustrates a diagram of an exemplary modified Clear to Send (CTS) frame in accordance with another aspect of the present disclosure.

FIG. 5 illustrates a block diagram of an exemplary communication system in a first configuration in accordance with another aspect of the present disclosure.

FIG. 6 illustrates a block diagram of an exemplary communication system in a second configuration in accordance with another aspect of the present disclosure.

FIG. 7 illustrates a block diagram of an exemplary communication system in a third configuration in accordance with another aspect of the present disclosure.

FIG. 8 illustrates a flow diagram of example operations of communication between two devices including determination of an interference sensitivity factor, in accordance with certain aspects of the present disclosure.

FIG. 9A illustrates a portion of a flow diagram of example operations of reusing a medium for wireless communication, in accordance with certain aspects of the present disclosure.

FIG. 9B illustrates another portion of the flow diagram shown in FIG. 9A, in accordance with certain aspects of the present disclosure.

FIG. 10 illustrates a flow diagram of example operations of determining an interference sensitivity factor based on interference related parameters, in accordance with certain aspects of the present disclosure.

FIG. 11 illustrates a flow diagram of example operations of reusing a medium for wireless communication, in accordance with certain aspects of the present disclosure.

FIG. 12 illustrates a block diagram of an exemplary communication system, in accordance with certain aspects of the present disclosure.

FIG. 13 illustrates a block diagram of an exemplary device in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. For example, the transmission protocols may include institute of electrical and electronic engineers (IEEE) 802.11 protocol. In some aspects, the 802.11 protocol may include the 802.11ay and/or the 802.11ad protocols, as well as future protocols. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple access terminals. A TDMA system may allow multiple access terminals to share the same frequency channel by dividing the transmission signal into different time slots, each time slot being assigned to different access terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

### Example Wireless Communications System

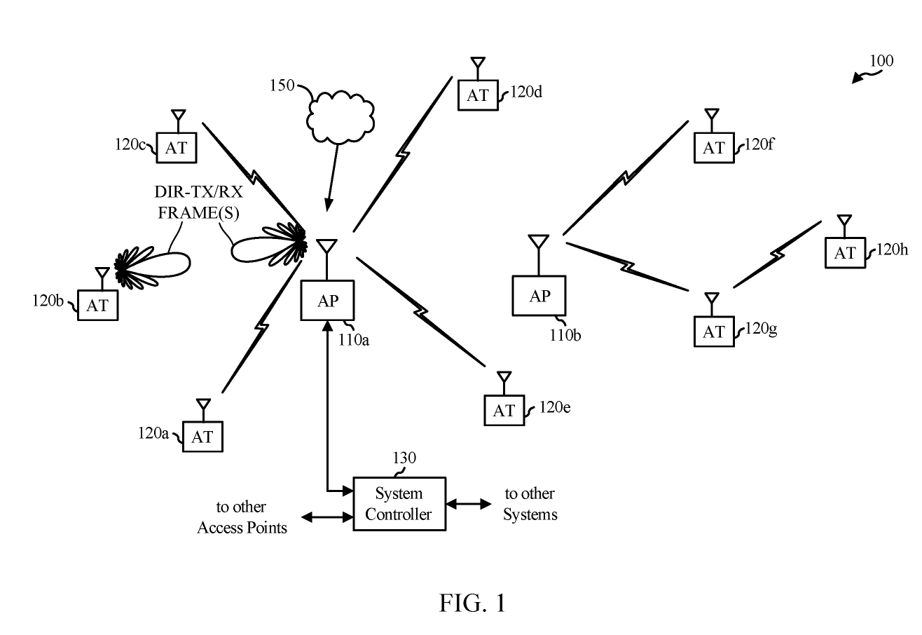

FIG. 1 illustrates a block diagram of an exemplary wireless communication system 100 with a plurality of wireless nodes, such as access points (APs) 110 and access terminals (ATs) 120. Certain aspects of the present disclosure relate generally to reducing interference among neighboring wireless devices, such as the APs 110 and ATs 120, as further described herein. For example, the AP 110a and AT 120b may transmit or receive directional frames (DIR-TX/RX FRAMES) having an interference sensitivity factor (ISF) that enables neighboring wireless devices (e.g., AP 110b or AT 120f) to reuse communication resources without interfering with, for example, the originating device (AP 110a or AT 120b) as further described herein.

Access points 110a and 110b are shown. An access point 110 is generally a fixed station that communicates with access terminals 120 and may also be referred to as a base station or some other terminology. An access terminal 120 may be fixed or mobile, and may be referred to as a mobile station, a wireless device, wireless node, or some other terminology. The access point 110a may communicate with one or more access terminals 120a to 120e at any given moment on the downlink and uplink, and the access point 110b may communicate with the access terminals access terminals 120f to 120h. The downlink (i.e., forward link) is the communication link from the access point 110 to the access terminals 120, and the uplink (i.e., reverse link) is the communication link from the access terminals 120 to the access point 110. An access terminal 120 may also communicate peer-to-peer with another access terminal 120. A system controller 130 couples to and provides coordination and control for the access points 110. The access point 110 may communicate with other devices coupled to a backbone network 150.

In one example, the wireless communication system 100 utilizes direct sequence spread spectrum (DSSS) modulation techniques in communication between the access point 110 and access terminals 120. The use of spread spectrum techniques allows for the system to readily manage and operate longer inter symbol interference (ISI) channels. In particular, code division multiple access (CDMA), readily facilitates increases in user capacity in systems of this size as compared to conventional cellular systems. More specifically, the access point 110 may be within a predefined geographical region, or cell, using several modulator-demodulator units or spread-spectrum modems to process communication signals. During typical operations, a modem in the access point 110 is assigned to each access terminal 120 as needed to accommodate transfer of communication signals. If the modem employs multiple receivers, then one modem accommodates diversity processing, otherwise multiple modems may be used in combination.

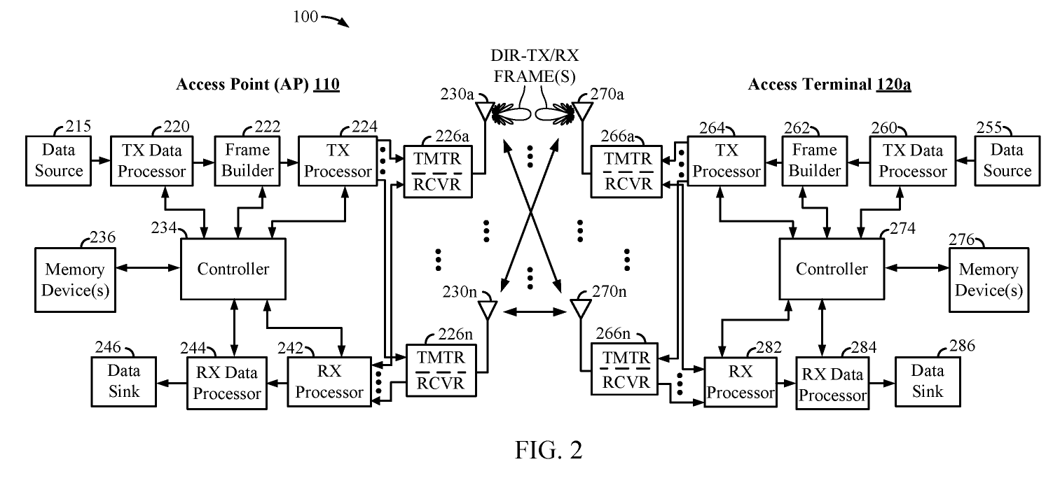

FIG. 2 illustrates a block diagram of the access point 110 (generally, a first wireless node) and an access terminal 120, for example, one of the access terminals 120a (generally, a second wireless node) in the wireless communication system 100. The AP 110 and AT 120 may transmit or receive directional frames (DIR-TX/RX FRAMES) having an ISF that enables neighboring wireless devices (APs or ATs) to reuse communication resources without interfering with, for example, the originating device (AP 110 or AT 120) as further described herein. The access point 110 is a transmitting entity for the downlink and a receiving entity for the uplink. The access terminal 120a is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel.

For transmitting data, the access point 110 comprises a transmit data processor 220, a frame builder 222, a transmit processor 224, a plurality of transceivers 226a through 226n, a bus interface for connecting the illustrated devices and components, and a plurality of antennas 230a through 230n. The access point 110 also comprises a controller 234 for controlling operations of the access point 110. In one embodiment, antennas 230a through 230n form a multi antenna phased array for multiple, steerable beams that can be directed to specific users. In this embodiment, isolation between users may be increased using the antenna array. The antennas may also be configured for equal gain beamforming (EGB) techniques and null steering techniques via phase control.

In operation, the transmit data processor 220 receives data (e.g., data bits) from a data source 215, and processes the data for transmission. For example, the transmit data processor 220 may encode the data (e.g., data bits) into encoded data, and modulate the encoded data into data symbols. The transmit data processor 220 may support different modulation and coding schemes (MCSs). For example, the transmit data processor 220 may encode the data (e.g., using low-density parity check (LDPC) encoding) at any one of a plurality of different coding rates. Also, the transmit data processor 220 may modulate the encoded data using any one of a plurality of different modulation schemes, including, but not limited to, binary phase-shift keying (BPSK), quadrature phase-shift keying (QPSK), quadrature amplitude modulation (QAM) (for example, 16QAM, 64QAM, and 256QAM), and amplitude and phase-shift keying or asymmetric phase-shift keying (APSK) (for example, 64 APSK, 128 APSK, and 256 APSK).

In certain aspects, the controller 234 may send a command to the transmit data processor 220 specifying which modulation and coding scheme (MCS) to use (e.g., based on channel conditions of the downlink), and the transmit data processor 220 may encode and modulate data from the data source 215 according to the specified MCS. It is to be appreciated that the transmit data processor 220 may perform additional processing on the data such as data scrambling, and/or other processing. The transmit data processor 220 outputs the data symbols to the frame builder 222.

The frame builder 222 constructs, or generates, a frame (also referred to as a packet), and inserts the data symbols into a data payload of the frame. The frame may include a preamble, a header, and the data payload. In one embodiment, the frame is any of a beacon frame, a probe request frame, or a probe response frame. The frame may include interference information such as an interference sensitivity factor (ISF), transmit power, or a reciprocity factor, in the form of a class as described in greater detail below. The preamble may include a short training field (STF) sequence and a channel estimation field (CEF) sequence to assist the access terminal 120a in receiving the frame. The header may include information related to the data in the payload such as the length of the data and the MCS used to encode and modulate the data. This information allows the access terminal 120a to demodulate and decode the data. The data in the payload may be divided among a plurality of blocks, wherein each block may include a portion of the data and a guard interval (GI) to assist the receiver with phase tracking. The frame builder 222 outputs the frame to the transmit processor 224.

The transmit processor 224 processes the frame for transmission on the downlink. For example, the transmit processor 224 may support different transmission modes such as an orthogonal frequency-division multiplexing (OFDM) transmission mode and a single-carrier (SC) transmission mode. In this example, the controller 234 may send a command to the transmit processor 224 specifying which transmission mode to use, and the transmit processor 224 may process the frame for transmission according to the specified transmission mode. The transmit processor 224 may apply a spectrum mask to the frame so that the frequency constituent of the downlink signal meets certain spectral requirements.

In certain aspects, the transmit processor 224 may support multiple-output-multiple-input (MIMO) transmission. In these aspects, the access point 110 may include multiple antennas 230a through 230n and multiple transceivers 226a through 226n (e.g., one for each antenna). The transmit processor 224 may perform spatial processing on the incoming frames and provide a plurality of transmit frame streams for the plurality of antennas. The transceivers 226a through 226n receive and processes (e.g., converts to analog, amplifies, filters, and frequency upconverts) the respective transmit frame streams to generate transmit signals for transmission via the antennas 230a through 230n, respectively.

The transmit processor 224 may be configured to transmit a plurality of training signals associated with a transmit beamforming training portion of an 802.11 beamforming training protocol (e.g., 802.11ad, 802.11ay, or future beamforming training protocols) between the access point 110 and one or more access terminals 120a. In one example, the beamforming training protocol may include sector level sweep (SLS) and a beam refinement phase for transmission (BRP-Tx).

For transmitting data, the access terminal 120a comprises a transmit data processor 260, a frame builder 262, a transmit processor 264, a plurality of transceivers 266a through 266n, a bus interface for connecting the illustrated devices and components, and a plurality of antennas 270a through 270n (e.g., one antenna per transceiver). The access terminal 120a may transmit data to the access point 110 on the uplink, and/or transmit data to another access terminal 120 (e.g., for peer-to-peer communication). The access terminal 120a also comprises a controller 274 for controlling operations of the access terminal 120a. In one embodiment, antennas 270a through 270n form an antenna array for multiple, steerable beams that can be directed to specific users. In this embodiment, isolation between users may be increased using the antenna array. The antennas may also be configured for equal gain beamforming (EGB) techniques and null steering techniques via, for example, phase control.

In operation, the transmit data processor 260 receives data (e.g., data bits) from a data source 255, and processes (e.g., encodes and modulates) the data for transmission. The transmit data processor 260 may support different MCSs. For example, the transmit data processor 260 may encode the data (e.g., using LDPC encoding) at any one of a plurality of different coding rates, and modulate the encoded data using any one of a plurality of different modulation schemes, including, but not limited to, BPSK, QPSK, 16QAM, 64QAM, 64 APSK, 128 APSK, 256QAM, and 256 APSK. In certain aspects, the controller 274 may send a command to the transmit data processor 260 specifying which MCS to use (e.g., based on channel conditions of the uplink), and the transmit data processor 260 may encode and modulate data from the data source 255 according to the specified MCS. It is to be appreciated that the transmit data processor 260 may perform additional processing on the data. The transmit data processor 260 outputs the data symbols to the frame builder 262.

The frame builder 262 constructs, or generates a frame, and inserts the received data symbols into a data payload of the frame. The frame may include a preamble, a header, and the data payload. In one embodiment, the frame is a beacon frame. The beacon frame may include interference information such as an interference sensitivity factor (ISF), transmit power, or a reciprocity factor, described in greater detail below. The preamble may include an STF sequence and a CEF sequence to assist the access point 110 and/or other access terminal 120 in receiving the frame. The header may include information related to the data in the payload such as the length of the data and the MCS used to encode and modulate the data. The data in the payload may be divided among a plurality of blocks where each block may include a portion of the data and a guard interval (GI) assisting the access point 110 and/or other access terminal 120 with phase tracking. The frame builder 262 outputs the frame to the transmit processor 264.

The transmit processor 264 processes the frame for transmission. For example, the transmit processor 264 may support different transmission modes such as an OFDM transmission mode and an SC transmission mode. In this example, the controller 274 may send a command to the transmit processor 264 specifying which transmission mode to use, and the transmit processor 264 may process the frame for transmission according to the specified transmission mode. The transmit processor 264 may apply a spectrum mask to the frame so that the frequency constituent of the uplink signal meets certain spectral requirements.

The transceivers 266a through 266n receive and process (e.g., converts to analog, amplifies, filters, and frequency upconverts) the output of the transmit processor 264 for transmission via the one or more antennas 270a through 270n. For example, the transceiver 266 may up-convert the output of the transmit processor 264 to a transmit signal having a frequency in the 60 GHz range.

In certain aspects, the transmit processor 264 may support multiple-output-multiple-input (MIMO) transmission. In these aspects, the access terminal 120 may include multiple antennas 270a through 270n and multiple transceivers 266a through 266n (e.g., one for each antenna). The transmit processor 264 may perform spatial processing on the incoming frame and provide a plurality of transmit frame streams for the plurality of antennas 270a through 270n. The transceivers 266a through 266n receive and process (e.g., converts to analog, amplifies, filters, and frequency upconverts) the respective transmit frame streams to generate transmit signals for transmission via the antennas 270a through 270n.

The transmit processor 264 may be configured to transmit a plurality of training signals associated with a transmit beamforming training portion of an 802.11 beamforming training protocol (e.g., 802.11ad, 802.11ay, or future beamforming training protocols) between the access point 110 and one or more access terminals 120a. In one example, the beamforming training protocol may include sector level sweep (SLS) and a beam refinement phase for transmission (BRP-Tx).

For receiving data, the access point 110 comprises a receive processor 242, and a receive data processor 244. In operation, the transceivers 226a through 226n receive a signal (e.g., from the access terminal 120a), and spatially process (e.g., frequency down-converts, amplifies, filters and converts to digital) the received signal. The received signal(s) may also be processed such that the phase and gain can be controlled with beamforming algorithms. The beamforming algorithms may control the phase (i.e., phase shifting) and gain of each antenna, and include linear spatial techniques, such as a channel correlation matrix inversion (CCMI) technique, a minimum mean square error (MMSE) technique, an equal gain beamforming technique, and others. The beamforming algorithms may also include space-time techniques, such as a minimum mean square error linear equalizer (MMSE-LE) technique, a decision feedback equalizer (DFE) technique, a maximal ratio combining technique (MRC), and others.

The receive processor 242 and the receive data processor 244 may be configured to receive a plurality of training signals associated with a transmit beamforming training portion of an 802.11 beamforming training protocol (e.g., 802.11ad, 802.11ay, or future beamforming training protocols) between the access point 110 and one or more access terminals 120a. For example, the beamforming training protocol may include sector level sweep (SLS) and a beam refinement phase for receiving (BRP-Rx).

The receive processor 242 receives the outputs of the transceivers 226a through 226n, and processes the outputs to recover data symbols. For example, the access point 110 may receive data (e.g., from the access terminal 120a) in a frame. In this example, the receive processor 242 may detect the start of the frame using the STF sequence in the preamble of the frame. The receiver processor 242 may also use the STF for automatic gain control (AGC) adjustment. The receive processor 242 may also perform channel estimation (e.g., using the CEF sequence in the preamble of the frame) and perform channel equalization on the received signal based on the channel estimation.

Further, the receiver processor 242 may estimate phase noise using the guard intervals (GIs) in the payload, and reduce the phase noise in the received signal based on the estimated phase noise. The phase noise may be due to noise from a local oscillator in the access terminal 120a and/or noise from a local oscillator in the access point 110 used for frequency conversion. The phase noise may also include noise from the channel. The receive processor 242 may also recover information (e.g., MCS scheme) from the header of the frame, and send the information to the controller 234. After performing channel equalization and/or phase noise reduction, the receive processor 242 may recover data symbols from the frame, and output the recovered data symbols to the receive data processor 244 for further processing.

The receive data processor 244 receives the data symbols from the receive processor 242 and an indication of the corresponding multi-scale control (MSC) scheme from the controller 234. The receive data processor 244 demodulates and decodes the data symbols to recover the data according to the indicated MSC scheme, and outputs the recovered data (e.g., data bits) to a data sink 246 for storage and/or further processing.

As discussed above, the access terminal 120a may transmit data using an OFDM transmission mode or a SC transmission mode. In this case, the receive processor 242 may process the receive signal according to the selected transmission mode. Also, as discussed above, the transmit processor 264 may support multiple-output-multiple-input (MIMO) transmission. In this case, the access point 110 includes multiple antennas 230a through 230n and multiple transceivers 226a through 226n (e.g., one for each antenna). Each transceiver receives and processes (e.g., frequency downconverts, amplifies, filters, and converts to digital) the signal from the respective antenna. The receive processor 242 may perform spatial processing on the outputs of the transceivers 226a through 226n to recover the data symbols.

For receiving data, the access terminal 120a comprises a receive processor 282, and a receive data processor 284. In operation, the transceivers 266a through 266n receive a signal (e.g., from the access point 110 or another access terminal 120) via the respective antennas 270a through 270n, and process (e.g., frequency downconverts, amplifies, filters and converts to digital) the received signal. The received signal(s) may also be processed such that the phase and gain can be controlled with beamforming algorithms. The beamforming algorithms may control the phase (i.e., phase shifting) and gain of each antenna, and include linear spatial techniques, such as a channel correlation matrix inversion (CCMI) technique, a minimum mean square error (MMSE) technique, an equal gain beamforming technique, and others. The beamforming algorithms may also include space-time techniques, such as a minimum mean square error linear equalizer (MMSE-LE) technique, a decision feedback equalizer (DFE) technique, a maximal ratio combining technique (MRC), and others.

The receive processor 282 and the receive data processor 284 may be configured to receive a plurality of training signals associated with a transmit beamforming training portion of an 802.11 beamforming training protocol (e.g., 802.11ad, 802.11ay, or future beamforming training protocols) between the access point 110 and one or more access terminals 120a. For example, the beamforming training protocol may include sector level sweep (SLS) and a beam refinement phase for receiving (BRP-Rx).

The receive processor 282 receives the outputs of the transceivers 266a through 266n, and processes the outputs to recover data symbols. For example, the access terminal 120a may receive data (e.g., from the access point 110 or another access terminal 120) in a frame, as discussed above. In this example, the receive processor 282 may detect the start of the frame using the STF sequence in the preamble of the frame. The receive processor 282 may also perform channel estimation (e.g., using the CEF sequence in the preamble of the frame) and perform channel equalization on the received signal based on the channel estimation.

Further, the receiver processor 282 may estimate phase noise using the guard intervals (GIs) in the payload, and reduce the phase noise in the received signal based on the estimated phase noise. The receive processor 282 may also recover information (e.g., MCS scheme) from the header of the frame, and send the information to the controller 274. After performing channel equalization and/or phase noise reduction, the receive processor 282 may recover data symbols from the frame, and output the recovered data symbols to the receive data processor 284 for further processing.

The receive data processor 284 receives the data symbols from the receive processor 282 and an indication of the corresponding MSC scheme from the controller 274. The receiver data processor 284 demodulates and decodes the data symbols to recover the data according to the indicated MSC scheme, and outputs the recovered data (e.g., data bits) to a data sink 286 for storage and/or further processing.

As discussed above, the access point 110 or another access terminal 120 may transmit data using an OFDM transmission mode or a SC transmission mode. In this case, the receive processor 282 may process the receive signal according to the selected transmission mode. Also, as discussed above, the transmit processor 224 may support multiple-output-multiple-input (MIMO) transmission. In this case, the access terminal 120a may include multiple antennas and multiple transceivers (e.g., one for each antenna). Each transceiver receives and processes (e.g., frequency downconverts, amplifies, filters, and converts to digital) the signal from the respective antenna. The receive processor 282 may perform spatial processing on the outputs of the transceivers to recover the data symbols.

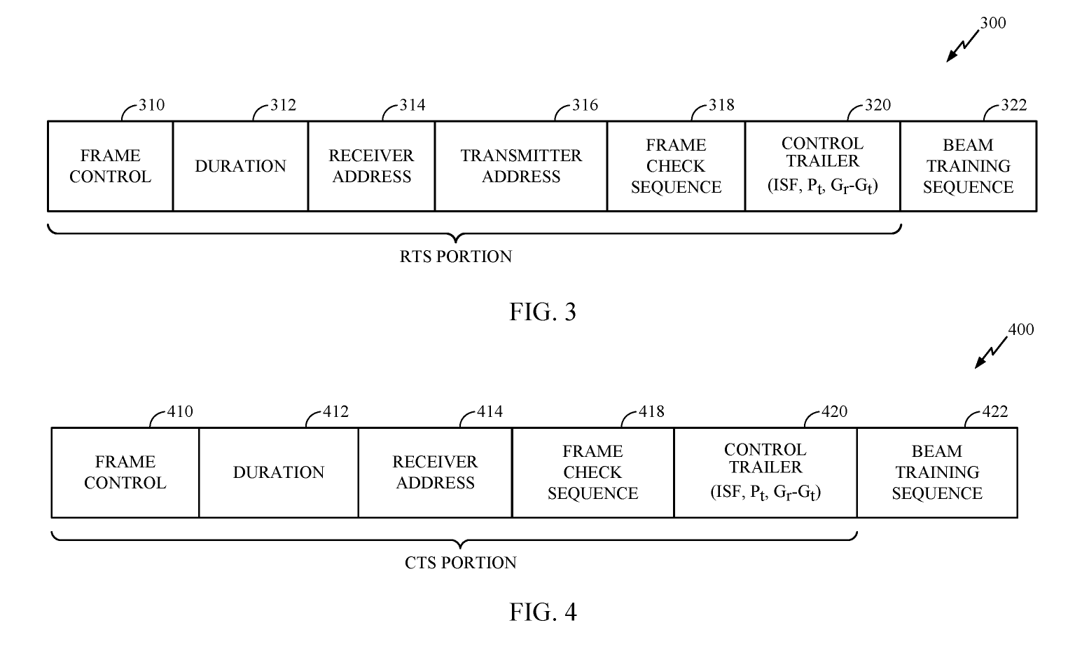

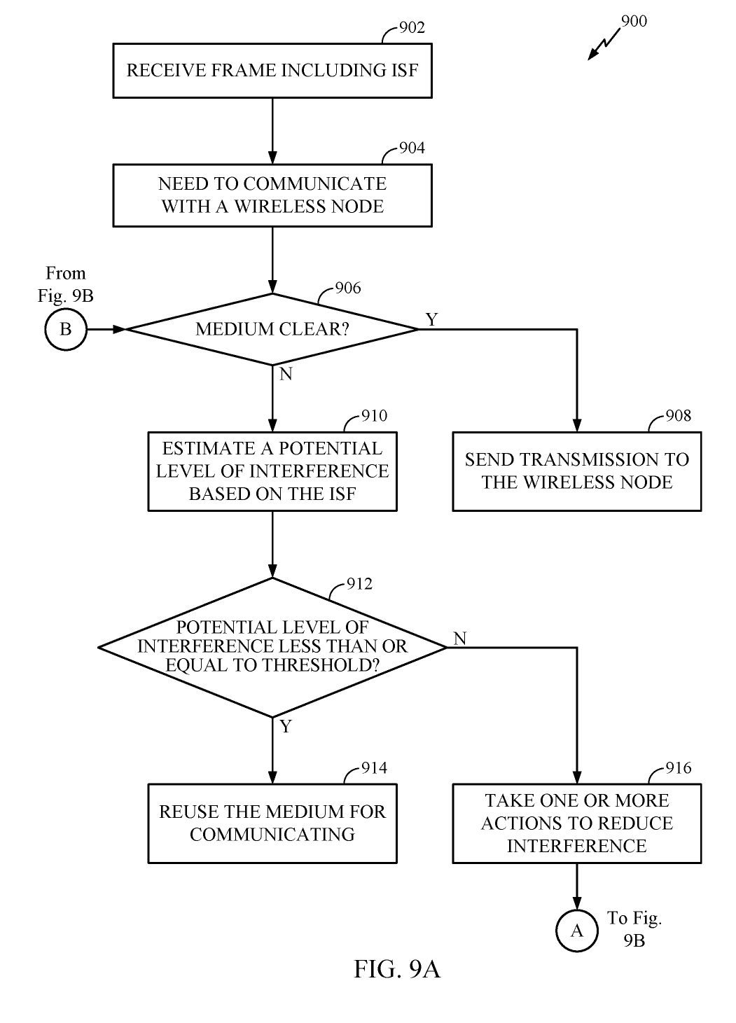

As shown in FIG. 2, the access point 110 also comprises a memory device(s) 236 coupled to the controller 234. The memory device(s) 236 may store instructions that, when executed by the controller 234, cause the controller 234 to perform one or more of the operations described herein, such as the operations illustrated in FIGS. 8, 9, 10, and 11. Similarly, the access terminal 120a also comprises a memory device(s) 276 coupled to the controller 274. The memory device(s) 276 may store instructions that, when executed by the controller 274, cause the controller 274 to perform the one or more of the operations described herein. The memory device(s) 236 and 276 may store data to assist the access point 110 and access terminal 120a in estimating interference information at one or more neighboring devices, as described in more detail further herein, with respect to FIGS. 3-13.

FIG. 3 illustrates a diagram of an exemplary modified Request to Send (RTS) frame 300 in accordance with another aspect of the present disclosure. A wireless device (referred to herein as an “originating device”) may use an RTS frame to initiate a communication period (TxOP) with a “destination device.” In response to receiving the RTS frame, the destination device sends a Clear to Send (CTS) frame back to the originating device if the device is available to receive and the communication medium is available. In response to receiving the CTS frame, the originating device sends the one or more data frames to the destination device. These RTS frames and CTS frames are examples of media access control (MAC) frames.

With regard to the frame details, the RTS frame 300 comprises an RTS portion including a frame control field 310, a duration field 312, a receiver address field 314, a transmitter address field 316, a frame check sequence field 318, and a control trailer (CT) field 320. As discussed in more detail herein, the control trailer 320 includes information that allows a neighboring (non-destination) device to estimate potential interference at the originating device if the neighboring device transmits a signal. Such information may include at least one of an interference sensitivity factor (ISF), transmit power Pₜ, or a reciprocity factor Gᵣ−Gₜ (a difference between the antenna receive gain and the antenna transmit gain).

For improved communication and interference reduction purposes as discussed in more detail in U.S. Provisional Patent application, Ser. No. 62/273,397 (which is incorporated herein by reference), the RTS frame 300 further includes a beam training sequence field 322 for configuring respective antennas of a neighboring device. The neighboring device may use the beam training sequence field 322 to estimate the relative angular direction of the ISF transmitter and/or its antenna gain at the ISF transmitter direction. The neighboring device may use this estimation for the angular direction and antenna gain to estimate the interference level it will cause. The neighboring device may also use the beam training sequence field 322 to configure its antenna for transmission so as to reduce interference at the originating device, such as by configuring its transmit antenna radiation pattern to have nulls aimed substantially at the direction of the originating device. The beam training sequence in the beam training sequence field 322 may be based on a Golay sequence.

The RTS portion of the RTS frame 300 may be configured as a standard RTS frame specified in the institute of electrical and electronic engineers (IEEE) 802.11 protocols. In this regard, the frame control field 310 includes the following subfields: a “protocol” subfield for specifying a version associated with the RTS frame portion; a “type” subfield for indicating a type of the frame (e.g., type=01 for a control frame); a “subtype” subfield for indicating a subtype of the frame (e.g., subtype=1011 indicates an RTS frame); and “ToDS” and “FromDS” subfields to indicate whether a distribution system sends and receives the control frames (e.g., ToDS=0 and FromDS=0 for an RTS frame).

The duration field 312 of the RTS portion of the RTS frame 300 provides an indication of an estimated duration for which the originating device will be communicating with the destination device. Or, in other words, the duration field 312 specifies an estimate of the duration in which the communication medium will be used to effectuate the communication between the originating device and the destination device. The duration may include the following cumulative durations: (1) duration of a Short Interframe Space (SIFS) between the end of the transmission of the RTS frame and the beginning of the transmission of the CTS frame; (2) duration of the CTS frame; (3) duration of another SIFS between the end of the transmission of the CTS frame and the beginning of the transmission of the one or more data frames; (4) duration of the one or more data frames; (5) duration of another SIFS between the end of the transmission of the one or more data frames and the beginning of the transmission of the ACK frame; and (6) duration of the ACK frame. As discussed in more detail further herein, one or more neighboring devices may use the duration to determine whether to estimate potential interference at the originating device based on a transmission scheme.

The receiver address field 314 of the RTS frame 300 indicates the address (e.g., media access control (MAC) address) of the destination device. As discussed in more detail, devices that receive the RTS frame 300 may perform different operations depending on whether the device is the destination device or a non-destination neighboring device. The transmitter address field 316 of the RTS portion of the RTS frame 300 indicates the address (e.g., MAC address) of the originating device. The frame check sequence field 318 of the RTS portion of the RTS frame 300 includes a value that allows receiving devices to determine the validity of at least some of the information transmitted via the RTS portion of the RTS frame 300.

As previously discussed, the control trailer 320 includes at least one of an ISF, Pₜ, or Gᵣ−Gₜ. A neighboring device that receives the RTS frame 300 may estimate potential interference at the originating device based on the received power level of the RTS frame 300, one or more of the information ISF, Pₜ, or Gᵣ−Gₜ, its transmit power, and its antenna's own reciprocity. The interference is the power level of a signal transmitted by the neighboring device at the input of a receiver of the originating device. If the estimated potential interference at the originating device is too high (e.g., greater than or equal to a threshold), the neighboring device may perform any number of responsive operations, such as not transmitting, choosing a different transmit sector for transmitting the signal, or reducing the transmission power of the signal if that is a suitable option based on whether the signal may be adequately received by a target device.

Based on the ISF, a neighboring device may estimate potential interference at the originating device using the following equation:

Pᵣₐ=P_{rb}+P_{tb}+(G_{tb}−G_{rb})−ISFₐ Equation 1

Where Pᵣₐ is the potential interference or power level at the receiver input of the originating device, P_{rb} is the power level of the RTS frame 300 at the receiver input of the neighboring device, P_{tb} is the transmit power of the neighboring device, G_{tb}−G_{rb} is the reciprocity (of the neighboring device, and ISFₐ is the interference sensitivity factor received from the originating device.

Based on Pₜ and Gᵣ−Gₜ, a neighboring device may estimate potential interference at the originating device using the following equation:

Pᵣₐ=P_{rb}+P_{tb}+(G_{tb}−G_{rb})−Pₜₐ+(Gᵣₐ−Gₜₐ) Equation 2

Where Pᵣₐ is the transmit power of the originating device, and Gᵣₐ−Gᵣₐ is the negative of the reciprocity factor of the originating device.

Based on Pt (and not ISF or Gᵣ−Gₜ), a neighboring device may estimate potential interference at the originating device using the following equation:

Pᵣₐ=P_{rb}+P_{tb}+(G_{tb}−G_{rb})−Pₜₐ Equation 3

As indicated, Equation 3 is an abbreviated version of Equation 2. In other words, the reciprocity factor of the originating device is missing because it was not communicated to the neighboring devices. In such case, the neighboring device may use Equation 3 to estimate the potential interference Pᵣₐ at the originating device with the assumption that the reciprocity factor of the originating device is zero (0). Alternatively, the neighboring device may make an assumption as to the reciprocity factor of the originating device and use Equation 2 with Gᵣₐ−Gₜₐ being an assumed value.

Based on Gₜ−Gₜ (and not ISF or Pₜ), a neighboring device may estimate potential interference at the originating device using the following equation:

Pᵣₐ=P_{rb}+(G_{tb}−G_{rb})+(Gᵣₐ−Gₜₐ) Equation 4

As indicated, Equation 4 is an abbreviated version of Equation 2. That is, the difference between the transmit power P_{tb} of the neighboring device and the transmit power Pₜₐ of the originating device is missing because Pₜₐ was not communicated to the neighboring device. In such case, the neighboring device may use Equation 4 to estimate the potential interference Pᵣₐ at the originating device with the assumption that the transmit power P_{tb} of the neighboring device is equal to the transmit power Pᵣₐ of the originating device. Alternatively, the neighboring device may make an assumption as to the difference in the transmit powers and use Equation 2 with P_{tb}−Pₜₐ being an assumed value. Alternatively, the ISF may be related to the transmit power Pₜₐ and the receive sensitivity of the originating device.

As mentioned above, based on the estimate of the potential interference Pᵣₐ at the originating device, the neighboring device may perform certain operation. For example, if the potential interference Pᵣₐ is less than (or equal to) a threshold (such that the interference would not be considered significant at the originating device, e.g., may not impact the reception of communications from the destination device by the originating device), the neighboring device may use the transmission scheme for communicating with a target device. The threshold may be defined as the maximum acceptable interference where the phrase “less than (or equal to) a threshold” as used herein is applicable. Alternatively, the threshold may be defined as the minimum unacceptable interference where the phrase “greater than or equal to” as used herein is applicable.

If the potential interference Pᵣₐ is greater than or equal to a threshold (such that the interference would be considered significant at the originating device, e.g., may impact the reception of communications from the destination device by the originating device), the neighboring device may take actions to reduce the potential interference at the originating device. For example, the neighboring device may not communicate with the target device. Alternatively, the neighboring device may change the transmission sector (to a lesser optimal sector) for communicating with the target device; the use of the new sector may reduce the estimated interference to less than (or equal to) the threshold. Alternatively, the neighboring device may lower its transmit power to reduce the estimated interference to less than (or equal to) the threshold, as long as the lowered transmit power is acceptable for communicating with the target device.

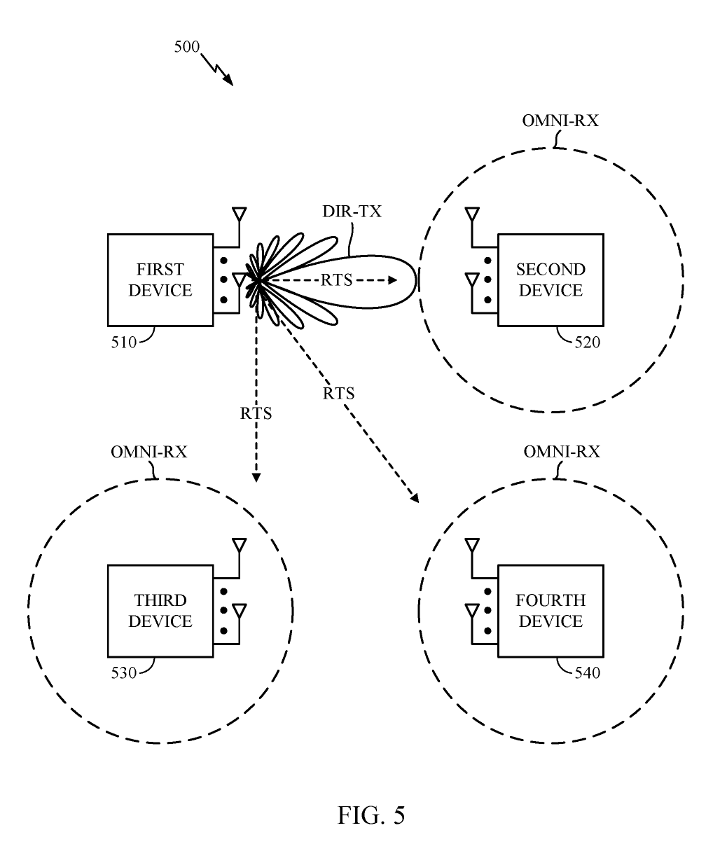

FIG. 4 illustrates a diagram of exemplary modified Clear to Send (CTS) frame, or CTS frame 400 in accordance with another aspect of the present disclosure. As previously discussed, a destination device transmits the CTS frame 400 to an originating device if the communication medium is available for transmission of one or more data frames from the originating device to the destination device.

In particular, the modified CTS frame 400 comprises a CTS portion including a frame control field 410, a duration field 412, a receiver address field 414, a frame check sequence field 418, and a control trailer 420. Similar to the control trailer 320 of the RTS frame 300, the control trailer 420 of the CTS frame 400 includes information that allows a neighboring (non-destination) device to estimate potential interference at the destination device based on a transmission scheme of the neighboring device. Again, such information may include at least one of an interference sensitivity factor (ISF), transmit power Pₜ, or reciprocity factor Gᵣ−Gₜ (the difference in the antenna receive gain and the antenna transmit gain).

For improved communication and interference reduction purposes as discussed in detail in U.S. Provisional patent application, Ser. No. 62/273,397, the CTS frame 400 further includes a beam training sequence field 422 for configuring respective antennas of a neighboring device. The neighboring device may use the beam training sequence field 422 to estimate the relative angular direction of the ISF transmitter and/or its antenna gain at the ISF transmitter direction. The neighboring device may use this estimation for the angular direction and antenna gain to estimate the interference level it will cause. The neighboring devices may also use the beam training sequence field 422 to configure its antenna for transmission so as to reduce interference at the destination device, such as by configuring its transmit antenna radiation pattern to have a null aimed substantially at the direction of the destination device. The beam training sequence in the beam training sequence field 422 may be based on a Golay sequence.

The frame control field 410 of the CTS portion of the CTS frame 400 includes essentially the same subfields as that of the RTS portion of the RTS frame 300, as previously discussed. The subfields of the frame control field 410 include the same values as the subfields of the frame control field 310 of the RTS portion of RTS frame 300, which the exception that the subtype subfield of the frame control field 410 is set to 1100 to indicate a CTS frame (instead of 1011 which indicates an RTS frame).

The duration field 412 of the CTS portion of the CTS frame 400 provides an indication of a remaining estimated duration for which the originating device will be communicating with the destination device. Or, in other words, the duration field 412 specifies an estimate of the remaining duration in which the communication medium will be used to effectuate the communication between the originating device and the destination device. In particular, the duration field 412 includes the duration indicated in the duration field 312 of the RTS portion of RTS frame 300, except that it does not include the cumulative durations of the CTS frame and the SIFS immediately before the CTS frame. More specifically, the duration may include the following cumulative durations: (1) duration of a SIFS between the end of the transmission of the CTS frame and the beginning of the transmission of the one or more data frames; (2) duration of the one or more data frames; (3) duration of another SIFS between the end of the transmission of the one or more data frames and the beginning of the transmission of the ACK frame; and (4) duration of the ACK frame.

The receiving address field 414 of the CTS portion of the CTS frame 400 indicates the address (e.g., MAC address) of the originating device. The frame check sequence field 418 of the CTS portion of the CTS frame 400 includes a value that allows receiving devices to determine the validity of at least some of the information transmitted via the CTS portion of the CTS frame 400.

As previously discussed, the control trailer 420 includes at least one of an ISF, Pₜ, or Gᵣ−Gₜ. A neighboring device that receives the CTS frame 400 may estimate potential interference at the destination device based on the received power level of the CTS frame 400, one or more of the information ISF, Pₜ, or Gᵣ−Gₜ, its transmit power, and its antenna's own reciprocity factor per, for example, using a suitable one of Equations 1-4. The neighboring device may perform the potential interference estimate if during a subsequent transmission coincides with the communication session between the originating device and the destination device based on the information in the duration field 412 of the CTS frame 400.

Similarly, if the estimated potential interference at the destination device is too high (e.g., greater than or equal to a threshold), the neighboring device may perform any number of responsive actions to eliminate or reduce the potential interference at the destination device as previously discussed. For instance, the responsive action may include withdrawing the transmission of a signal so as to eliminate the potential interference at the destination device, choose a different transmission sector for transmitting a signal so as to reduce the potential interference at the destination device, or reduce the transmission power (again to reduce the potential interference at the destination device) if the reduction in the transmit power is still suitable for communicating with a target device.

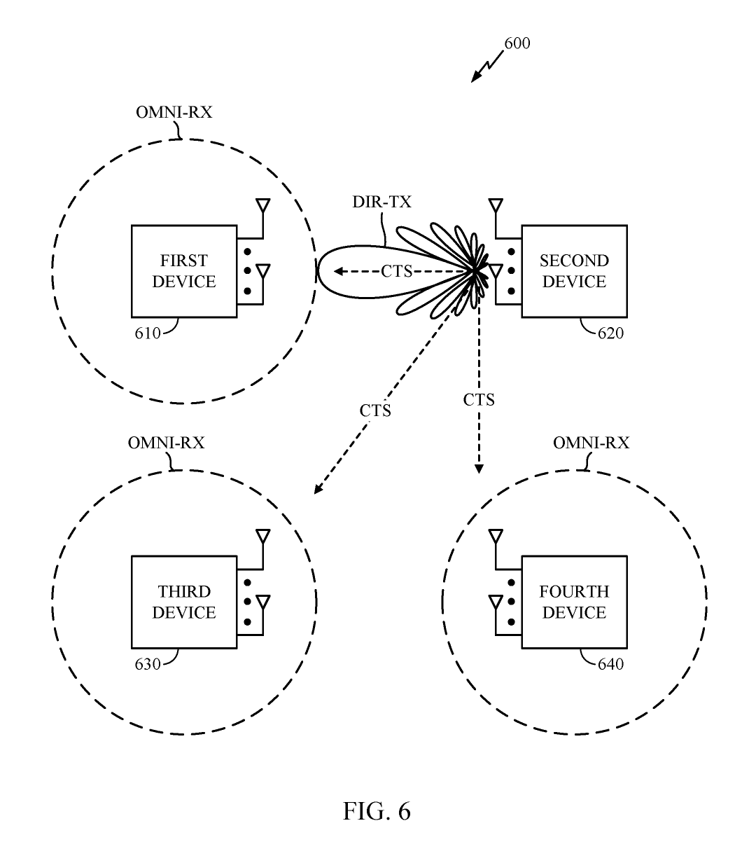

The following description with reference to FIGS. 5-7 provides examples of how the aforementioned MAC frames, in particular the RTS frame 300 and the CTS frame 400, are used to improve communication between an originating device and a destination device, such as by at least eliminating potential interference or reducing actual interference at the originating device and destination device from transmission by neighboring devices.

FIG. 5 illustrates a block diagram of an exemplary communication system 600 in a first configuration in accordance with another aspect of the present disclosure. As illustrated, the communication system 500 includes a plurality of wireless devices, such as a first device 510, a second device 520, a third device 530, and a fourth device 540. In this example, the first device 510 is an example of an originating device that will be transmitting one or more data frames to a destination device, which, in this example, is the second device 520. Also, in this example, the third device 530 is an example of a neighboring device to the first device 510 and the second device 520. Similarly, the fourth device 540 is another example of a neighboring device to the first device 510 and the second device 520.

Each of the first device 510, the second device 520, the third device 530, and the fourth device 540 includes an antenna with multiple antenna elements, allowing each of them to transmit and receive in an omnidirectional manner and in a directional manner. In the first configuration, the first device 510 has configured its antenna for directional transmission (DIR-TX) aimed approximately at the second device 520. The second device 520, the third device 530, and the fourth device 540 have configured their respective antennas for omnidirectional reception (OMNI-RX).

In the first configuration, the first device 510, operating as an originating device, transmits the RTS frame 300 with the receiver address field 314 indicating the address of the second device 520. In this example, the second device 520 receives the RTS frame 300, whereas the third device 530 and the fourth device 540 may receive the RTS frame 300. The second device 520 determines that it is the destination device based on the information in the receiver address field 314 in the RTS frame 300. Similarly, the third device 530 and the fourth device 540 determine that they are not the intended device (but merely neighboring devices to the first device 510) based on the information in the receiver address field 314 in the RTS frame 300.

As neighboring devices to the first device 510, the third device 530 and the fourth device 540 both receive and store one or more of the information in the duration field 312 and the control trailer 320 of the RTS frame 300. As discussed, the information in the control trailer 320 includes at least one of the interference sensitivity Factor (ISF), transmit power Pₜ, or reciprocity factor (Gᵣ−Gₜ) associated with the transmission of the RTS frame 300 by the first device 510. The third device 530 and the fourth device 540 also measure and store the power levels of the RTS frame 300 at the inputs of their respective receivers. The stored information may be used in the future to determine whether the third device 530 and/or the fourth device 540 need to estimate the potential interference at the first device 510 based on the information in the duration field 312 of the RTS frame 300, and if so, estimate the potential interference at the first device 510 based on the information (ISF, Pₜ, and/or Gᵣ−Gₜ) in the control trailer 320 of the RTS frame 300 and a transmission scheme between the third device 530 and the fourth device 540.

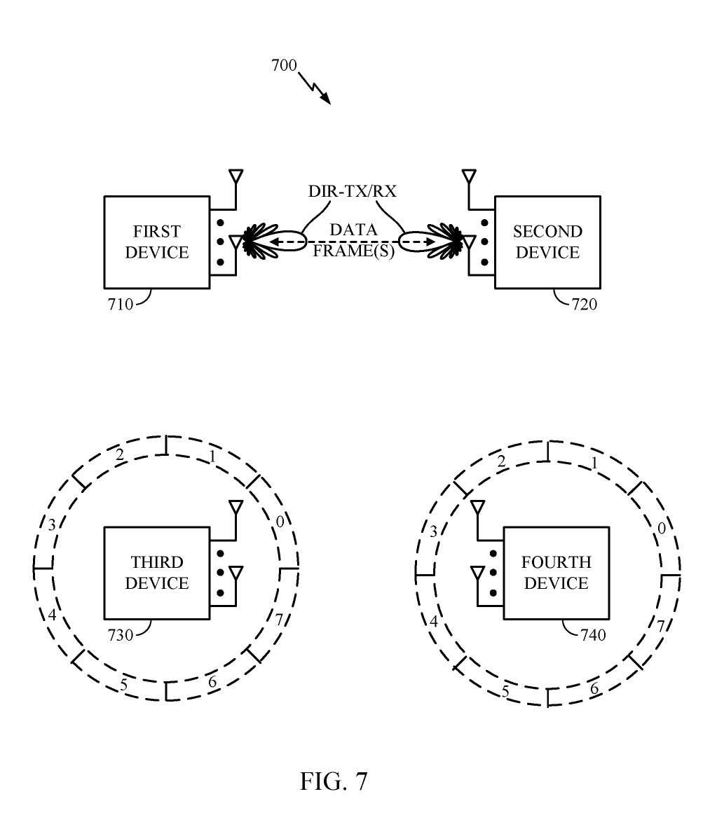

FIG. 6 illustrates a block diagram of the exemplary communication system 600 in a second configuration in accordance with another aspect of the present disclosure. In the second configuration, the second device 620 has determined that it is the destination device and, in response, optionally uses the beam training sequence in the beam training sequence field 322 of the received RTS 300 to configure its antenna for directional transmission aimed substantially at the first device 610. That is, the antenna of the second device 620 may be configured to generate an antenna radiation pattern with a primary lobe (e.g., highest gain lobe) aimed substantially at the first device 610, and non-primary lobes (e.g., lobes having distinct gains lower than that of the primary lobe) aimed in other directions (e.g., not aimed at the first device 610).

In the second configuration, the second device 620 transmits the CTS frame 400 with its antenna optionally configured for directional transmission aimed substantially at the first device 610. In this example, the first device 610 receives the CTS frame 400. Also, in accordance with this example, the third device 630 and fourth device 640 both receive the CTS frame 400. The third device 630 and the fourth device 640 determine that they are not the intended device (but merely neighboring devices to the second device 620) based on the information in the receiver address field 414 in the CTS frame 400.

As neighboring devices to the second device 620, the third device 630 and the fourth device 640 both receive and store one or more of the information in the duration field 412 and the control trailer 420 of the CTS frame 400. As discussed, the information in the control trailer 420 includes at least one of the interference sensitivity Factor (ISF), transmit power Pₜ, or reciprocity factor (Gᵣ−Gₜ) associated with the transmission of the CTS frame 400 by the second device 620. The third device 630 and the fourth device 640 also measure and store the power levels of the CTS frame 400 at the inputs of their respective receivers. The stored information may be used in the future to determine whether the third device 630 and/or the fourth device 640 need to estimate the potential interference at the second device 620 based on the information in the duration field 412 of the CTS frame 400, and if so, estimate the potential interference at the second device 620 based on the information (ISF, Pₜ, and/or Gᵣ−Gₜ) in the control trailer 420 of the CTS frame 400 and a transmission scheme between the third device 630 and the fourth device 640.

The interference information can be transmitted and received using fields in a MAC frame, such as the CTS frame 400 and/or the RTS frame 300. In one embodiment, the interference information may be indicated by one or more bits in a field of the frame. In another embodiment, the interference information may be indicated by an arrangement of fields in the frame. The interference information may identify the actual interference at a device. Another device receiving the interference information may determine the potential interference by using a lookup table stored on the other device, or by comparing the received interference information with values stored in a memory, for example in a central or cloud database.

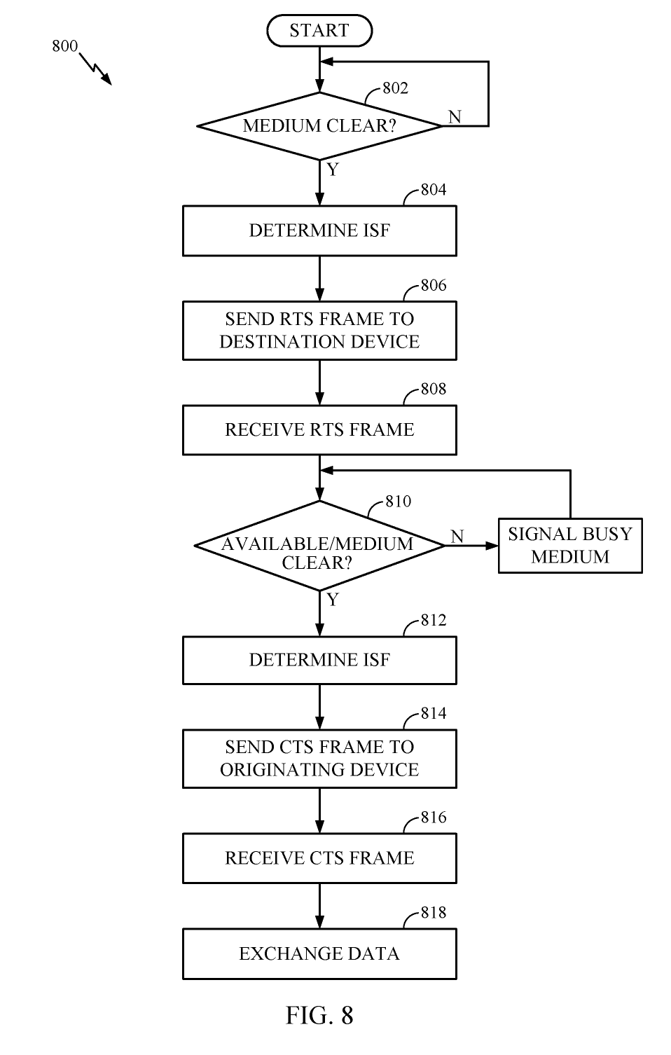

FIG. 7 illustrates a block diagram of the exemplary communication system 700 in a third configuration in accordance with another aspect of the present disclosure. In the third configuration, the first device 710 determines that it is the intended receiving device of the CTS frame 400 based on the address indicated in the receiver address field 414 of the CTS frame 400. In response to determining it is the intended receiving device of the CTS frame 400, the first device 710 may optionally use the beam training sequence in the beam training sequence field 422 of the received CTS frame 400 to configure its antenna for directional transmission aimed substantially at the second device 720.

Also, in the third configuration, the second device 720 may have optionally configured its antenna for directional reception (e.g., primary antenna radiation lobe) aimed at the first device 710. Thus, while the antenna of the first device 710 is configured for directional transmission to the second device 720, and the antenna of the second device 720 is configured for directional reception from the first device 710, the first device 710 transmits one or more data frames to the second device 720.

While the first device 710 is communicating with the second device 720, the third device 730 decides it needs to communicate with the fourth device 740 (e.g., transmit an RTS frame to the fourth device 740). The third device 730 determines a transmission scheme for transmitting a signal (e.g., an RTS frame) to the fourth device 740. The transmission scheme may include a transmit power Pₜ and an antenna radiation pattern, which may be characterized by a reciprocity factor Gₜ−Gᵣ. Then, the third device 730 determines whether the first device 710 and the second device 720 are communicating based on the information in one or both of the duration fields of the RTS frame 300 and/or CTS frame 400. If the third device 730 determines that the first device 710 is no longer communicating with the second device 720, the third device 730 proceeds with transmitting the signal (e.g., the RTS frame) to the fourth device 740 pursuant to the transmission scheme.

If, on the other hand, the third device 730 determines that the first device 710 and the second device 720 are communicating, the third device 730 estimates the respective potential interferences at the first device 710 and the second device 720 that would result if the third device transmits a signal to the fourth device 740 pursuant to the transmission scheme. The third device 730 may estimate the potential interference at the first device 710 using a suitable one of Equations 1-4, the information (e.g., ISF, Pₜ, or Gᵣ−Gₜ) in the control trailer 320 of the RTS frame 300 received from the first device 710, the power level of the RTS frame 300 at the input of the receiver of the third device 730, and the transmit power and reciprocity factor of the transmission scheme. Similarly, the third device 730 may estimate the potential interference at the second device 720 using a suitable one of Equations 1-4, the information (e.g., ISF, Pₜ, or Gᵣ−Gₜ) in the control trailer 420 of the CTS frame 400 received from the second device 720, the power level of the CTS frame 400 at the input of the receiver of the third device 730, and the transmit power and reciprocity factor of the transmission scheme.

If the third device 730 determines that the respective potential interference estimates at both the first device 710 and the second device 720 are less than (or equal to) a threshold (where the respective interferences would not significantly impact the communications between the first device 710 and the second device 720), the third device 730 proceeds with transmitting the signal (e.g., the RTS frame) to the fourth device 740 pursuant to the transmission scheme.

If, on the other hand, the third device 730 determines that the estimated potential interference at either or both the first device 710 and the second device 720 is greater than or equal to the threshold (where the respective interferences would significantly impact the communications between the first device 710 and the second device 720), the third device 730 may perform a particular action to eliminate or reduce interferences at the first device 710 and the second device 720.

For example, the third device 730 may decide to withdraw the transmission of the signal (e.g., the RTS frame) to the fourth device 740.

Alternatively, the third device 730 may decide to change the transmission sector pursuant to the transmission scheme to reduce the interferences at one or both the first device 710 and the second device 720. For example, the third device 730 may have selected sector “0” for transmission of a signal (e.g., an RTS frame) to the fourth device 740 pursuant to the transmission scheme. However, due to the estimated potential interference at the second device 720 being greater than or equal to the threshold, the third device 730 may decide to select sector “7” for transmission of the signal. In such case, the transmission of the signal via sector “7” results in an estimated potential interference at both the first device 710 and the second device 720 being less than (or equal to) the threshold. In this example, the original estimated interference at the first device 710 may have already been less than (or equal to) the threshold; and thus, the changing of the transmission sector from “0” to “7” is due to the estimated interference at the second device 720, not the first device 710. Accordingly, the third device 730 may proceed with transmitting the signal (e.g., an RTS frame) to the fourth device 740 via sector “7” pursuant to the modified transmission scheme.

As another example of modifying the transmission scheme, the third device 730 may reduce the transmit power of the transmission scheme to reduce the interference at one or both the first device 710 and the second device 720. For example, the transmit power of the transmission scheme may result in the estimated potential interference at the second device 720 being greater than or equal to the threshold. However, as a result of the reduced transmit power, the estimated potential interference at the second device 720 is less than (or equal to) the threshold. Similarly, in this example, the estimated potential interference at the first device 710 may have already been less than (or equal to) the threshold; and thus, the reduction in the transmit power is due to the estimated potential interference at the second device 720, not the first device 710. The third device 730 may now proceed with transmitting the signal (e.g., an RTS frame) to the fourth device 740 with the transmit power of the modified transmission scheme.

In response to receiving the signal (e.g., an RTS frame) from the third device 730, the fourth device 740 determines a transmission scheme for sending a responsive signal (e.g., a CTS frame) to the third device 730. Similarly, the transmission scheme may include a transmit power Pₜ and a antenna radiation pattern, which may be characterized by a reciprocity factor Gₜ−Gᵣ.

The fourth device 740 estimates the respective potential interferences at the first device 710 and the second device 720 that would result if the fourth device 740 transmits the signal to the third device 730 pursuant to the transmission scheme. The fourth device 740 may estimate the potential interference at the first device 710 using a suitable one of Equations 1-4, the information (e.g., ISF, Pₜ, or Gₜ−Gₜ) in the control trailer 320 of the RTS frame 300 received from the first device 710, the power level of the RTS frame 300 at the input of the receiver of the fourth device 740, and the transmit power and reciprocity factor of the transmission scheme. Similarly, the fourth device 740 may estimate the potential interference at the second device 720 using a suitable one of Equations 1-4, the information (e.g., ISF, Pₜ, or Gᵣ−Gₜ) in the control trailer 420 of the CTS frame 400 received from the second device 720, the power level of the CTS frame 400 at the input of the receiver of the fourth device 740, and the transmit power and reciprocity factor of the transmission scheme.

If the fourth device 740 determines that the respective potential interference estimates at both the first device 710 and the second device 720 are less than (or equal to) a threshold (where the respective interferences would not significantly impact the communications between the first device 710 and the second device 720), the fourth device 740 proceeds with transmitting the signal (e.g., the CTS frame) to the third device 730 pursuant to the transmission scheme.

If, on the other hand, the fourth device 740 determines that the estimated potential interference at either or both the first device 710 and the second device 720 is greater than or equal to the threshold (where the respective interference(s) would significantly impact the communications between the first device 710 and the second device 720), the fourth device 740 may perform a particular action to eliminate or reduce the interferences at the first device 710 and the second device 720. For example, the fourth device 740 may decide to withdraw the transmission of the signal (e.g., the CTS frame) to the third device 730.

Alternatively, the fourth device 740 may decide to change the transmission sector pursuant to the transmission scheme to reduce the interferences at one or both the first device 710 and the second device 720. For example, the fourth device 740 may have selected sector “3” for transmission of a signal (e.g., a CTS frame) to the third device 730 pursuant to the transmission scheme. However, due to the estimated potential interference at the first device 710 being greater than or equal to the threshold, the fourth device 740 may decide to select sector “4” for transmission of the signal. In such case, the transmission of the signal via sector “4” results in an estimated interferences at both the first device 710 and the second device 720 being less than (or equal to) the threshold. In this example, the original estimated interference at the second device 720 may have already been less than (or equal to) the threshold; and thus, the changing of the transmission sector from “3” to “4” is due to the estimated interference at the first device 710, not the second device 720. Accordingly, the fourth device 740 may proceed with transmitting the signal (e.g., a CTS frame) to the third device 730 via sector “4” pursuant to the modified transmission scheme.

As another example of modifying the transmission scheme, the fourth device 740 may reduce the transmit power of the transmission scheme to reduce the interference at one or both the first device 710 and the second device 720. For example, the transmit power of the transmission scheme may result in the estimated potential interference at the first device 710 being greater than or equal to the threshold. However, as a result of the reduced transmit power, the estimated interference at the first device 710 is less than (or equal to) the threshold. Similarly, in this example, the original estimated interference at the second device 720 may already have been less than (or equal to) the threshold; and thus, the reduction in the transmit power is due to the estimated interference at the first device 710, not the second device 720. The fourth device 740 may now proceed with transmitting the signal (e.g., a CTS frame) to the third device 730 via with the transmit power of the modified transmission scheme. It should be noted that device 510 may correspond to devices 610 and 710. Similarly, devices 520, 530, and 540 may correspond to devices 620 and 720, 630 and 730, and 640 and 740, respectively.

FIG. 8 is a flow diagram illustrating example operations 800 that may be performed, for example, by wireless nodes (510, 610, 710, 520, 620, 720), for allowing neighboring wireless nodes (530, 630, 730, 540, 640, 740) to reuse the medium. The wireless node (510, 610, 710, 520, 620, 720) determines its ISF based on one or more interference-related parameters, in accordance with certain aspects of the present disclosure. Operations 800 may begin, at 802, by the originating device (510, 610, 710) determining whether a medium is clear for wireless communications. At 804, if the medium is clear, the originating device (510, 610, 710) determines an interference sensitivity factor (ISF) based on interference-related parameters as further described herein. At 806, the originating device (510, 610, 710) sends an RTS frame (300) including the ISF determined at 804 to the destination device (520, 620, 720) using a beamforming antenna configuration. At 808, the destination device (520, 620, 720) receives the RTS frame (300) while monitoring the medium using a quasi-omnidirectional antenna configuration. At 810, the destination device (520, 620, 720) determines whether it is available to communicate with the originating device (510, 610, 710) and/or whether the medium is clear for communication. At 811, if the medium is not clear, the destination device (520, 620, 720) may respond to the originating device (510, 610, 710) with an indication that the medium is busy at the destination device (520, 620, 720). At 812, if the medium is clear, the destination device (520, 620, 720) determines its ISF based on interference-related parameters as further described herein. At 814, the destination device (520, 620, 720) sends a CTS frame (400) including the ISF determined at 812 to the originating device (510, 610, 710) using a beamforming antenna configuration. At 816, the originating device (510, 610, 710) receives the CTS frame using a beamforming or a quasi-omindirectional antenna configuration. At 818, the wireless devices (510, 610, 710, 520, 620, 720) begin exchanging data with each other using beamforming antenna configurations.

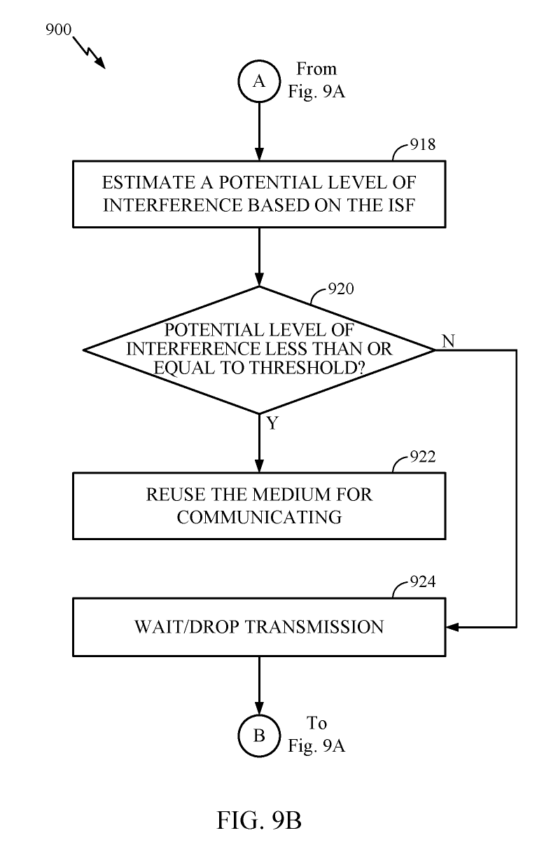

FIGS. 9A and 9B show a flow diagram of example operations 900 that may be performed, for example, by a neighboring wireless node (530, 630, 730, 540, 640, 740), for implementing spatial reuse using an ISF received in a frame, in accordance with certain aspects of the present disclosure. Operations 900 may begin, at 902, by a neighboring wireless device (530, 630, 730) receiving one or more RTS frame(s) (300) and/or CTS frame(s) (400) with ISF(s) from a wireless devices (510, 610, 710, 520, 620, 720) using directional or an quasi-omnidirectional antenna configuration. At 904, the neighboring wireless device (530, 630, 730) determines that it needs to communicate with another wireless device (540, 640, 740). For example, this may be due to a request from an application running on an upper layer of the neighboring wireless device (530, 630, 730). At 906, the neighboring wireless device (530, 630, 730) determines whether the medium is clear for communications. For example, the neighboring wireless device (530, 630, 730) may determine whether the medium is clear based on the RTS/CTS frames received at 902 as transmitted by the wireless nodes (510, 610, 710, 520, 620, 720), for example, according to the operations 800.

At 908, if the medium is clear, the neighboring wireless device (530, 630, 730) sends a transmission to the other neighboring wireless device (540, 640, 740). At 910, if the medium is not clear (e.g., the medium is reserved for communications between the wireless nodes (510, 610, 710, 520, 620, 720) based on the RTS/CTS frames of the operations 800), the neighboring wireless device (530, 630, 730) may take one or more actions described herein to reduce interference and reuse the medium. For example, at 910, the neighboring wireless device estimates a potential level of interference, at the wireless device (510, 610, 710, 520, 620, 720) associated with the received ISF, based at least in part on the ISF. At 912, the neighboring wireless device (530, 630, 730) determines whether the potential level of interference is less than or equal to a threshold. At 914, if the potential level of interference is less than or equal to the threshold, the neighboring wireless device (530, 630, 730) reuses the medium for communicating with another neighboring wireless device (540, 640, 740), for example, in accordance with operations 800 or other operations described herein. At 916, if the potential level of interference is greater than the threshold, the neighboring wireless device (530, 630, 730) may take one or more actions to reduce the interference at the wireless device (510, 610, 710, 520, 620, 720) associated with the received ISF as further described herein.

At 918, after taking one or more actions at 916, the neighboring wireless device (530, 630, 730) may re-estimate the potential level of interference based on the received ISF as further described herein. At 920, the neighboring wireless device (530, 630, 730) may determine whether the potential level of interference is less than or equal to the threshold. At 922, if the potential level of interference is less than or equal to the threshold, the neighboring wireless device (530, 630, 730) reuses the medium for communicating with the other neighboring wireless device (540, 640, 740), for example, in accordance with operations 800 or other operations described herein. At 924, if the potential level of interference is greater than the threshold, the neighboring wireless device (530, 630, 730) may wait for a specified duration and recheck whether the medium is clear at 906 or drop the request to transmit as obtained at 904.

### Example Spatial Reuse with Interference Sensitivity Factor

In certain aspects, spatial reuse of communication resources may be improved by adjusting the ISF factor based on interference-related parameters of the originating device (e.g., the first device 510 of FIG. 5) or the destination device (e.g., the second device 520 of FIG. 5). For example, the originating device 510 may adjust the ISF based on its receiver sensitivity or a link quality between the originating device 510 and the destination device 520 (e.g., received signal string indication (RSSI)). The originating device may then transmit this adjusted ISF (e.g., a control trailer of a PHY header may include the ISF) to enable neighboring wireless devices to reuse communication resources without interfering with, for example, the originating device as further described herein.

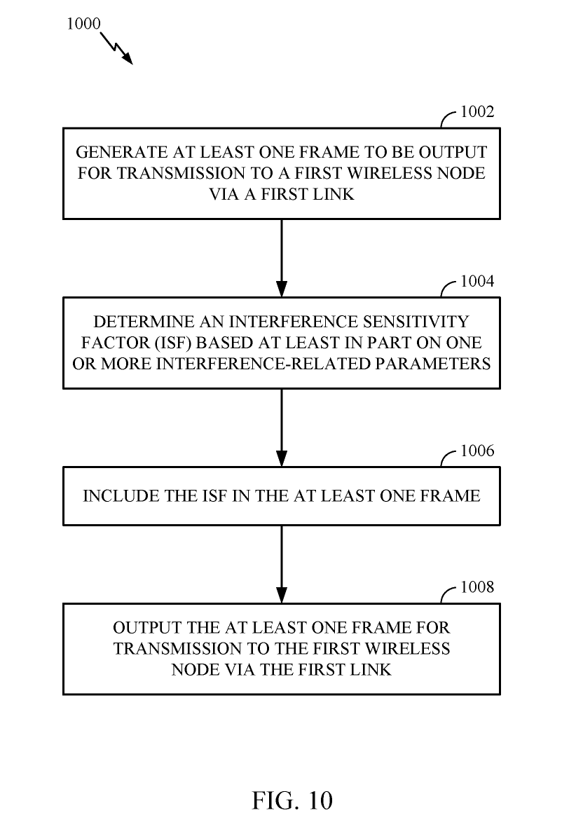

FIG. 10 is a flow diagram illustrating example operations 1000 that may be performed, for example, for implementing spatial reuse using an ISF based on one or more interference-related parameters, in accordance with certain aspects of the present disclosure. Operations 1000 may be implemented as software components that are executed and run on one or more processors (e.g., controller 234 or controller 274 of FIG. 2). Further, the transmission and reception of signals by the wireless node of operations 1000 may be enabled, for example, by one or more antennas (e.g., antennas 230 or antennas 270 of FIG. 2). Operations 1000 may be implemented by an originating device, such as the first device (510, 610, 710), which transmits an RTS frame 300 for communication with a destination device, for example, the second device (520, 620, 720). Similarly, operations 1000 may be implemented by a destination device, such as the second device (520, 620, 720), which transmits the CTS frame 400 in response to receiving an RTS frame 300 from an originating device, such as the first device (510, 610, 710).

Operations 1000 may begin, at 1002, by a wireless node (510, 610, 710) determining an interference sensitivity factor (ISF) from which a neighboring wireless node (530, 630, 730) is able to estimate a potential level of interference at the first wireless node due to transmissions from the third wireless node on a second link. The ISF is determined based at least in part on one or more interference-related parameters as further described herein. The frame generated may be a MAC frame, for example, an RTS frame or an CTS frame, depending on whether the wireless node is an originating device or a destination device of the first link.

At 1004, the wireless node (510, 610, 710) generates at least one frame to be output for transmission to a second wireless node (520, 620, 720) via a first link. The frame generated may be a MAC frame, for example, an RTS frame or an CTS frame, depending on whether the wireless node is an originating device or a destination device of the first link. In certain aspects, the determined ISF may be included in the header of a MAC frame, for example, in the control trailer of an RTS/CTS frame as described herein with respect to FIGS. 3 and 4. In certain aspects, the ISF may be included in a PHY header, a MAC header, or a MAC frame. In other words, the frame generated at 1004 may include a header or a control trailer (CT) carrying the ISF.

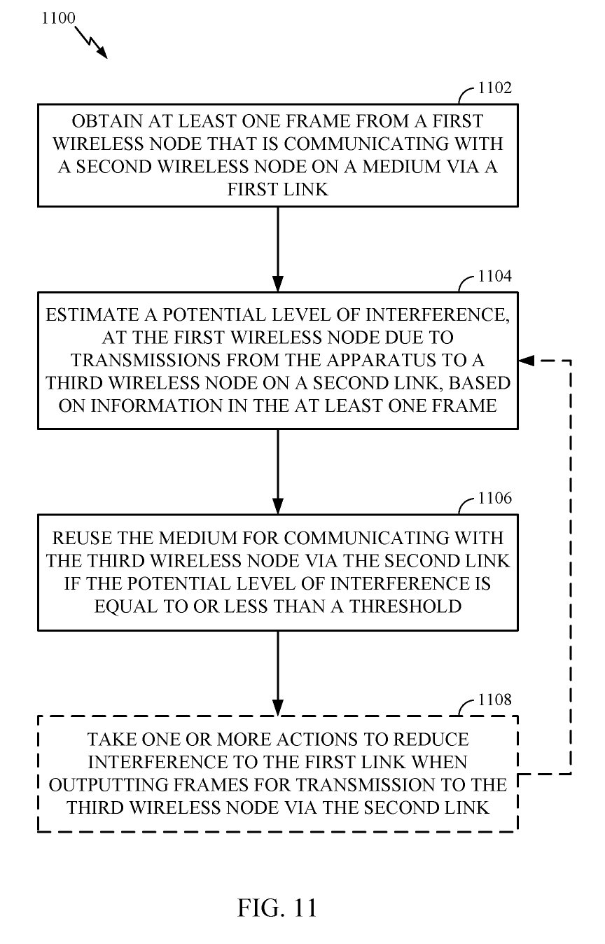

At 1006, the wireless node (510, 610, 710) outputs the at least one frame for transmission to the second wireless node (520, 620, 720) via the first link. As further described herein, the ISF enables the neighboring wireless nodes (530, 540) communicating via a second link to reduce the interference with the first link caused by transmissions on the second link. The wireless node (510, 610, 710) may output the at least one frame via an interface such as the transmit/receive interface 1130 of FIG. 11.

FIG. 11 is a flow diagram illustrating example operations 1100 that may be performed, for example, by a neighboring wireless node (530, 540), for implementing spatial reuse using an ISF based on one or more interference-related parameters, in accordance with certain aspects of the present disclosure. Operations 1100 may be implemented as software components that are executed and run on one or more processors (e.g., controller 234 or controller 274 of FIG. 2). Further, the transmission and reception of signals by the neighboring wireless node in operations 1100 may be enabled, for example, by one or more antennas (e.g., antennas 230 or antennas 270 of FIG. 2). Operations 1100 may be implemented by a neighboring wireless node to an originating wireless node or a destination wireless node. For example, operations 1100 may be implemented by the third device (530, 630, 730) to facilitate reuse of a medium for wireless communications. Similarly, operations 1100 may be implemented by the fourth device (540, 640, 740) to facilitate reuse of a medium for wireless communications.

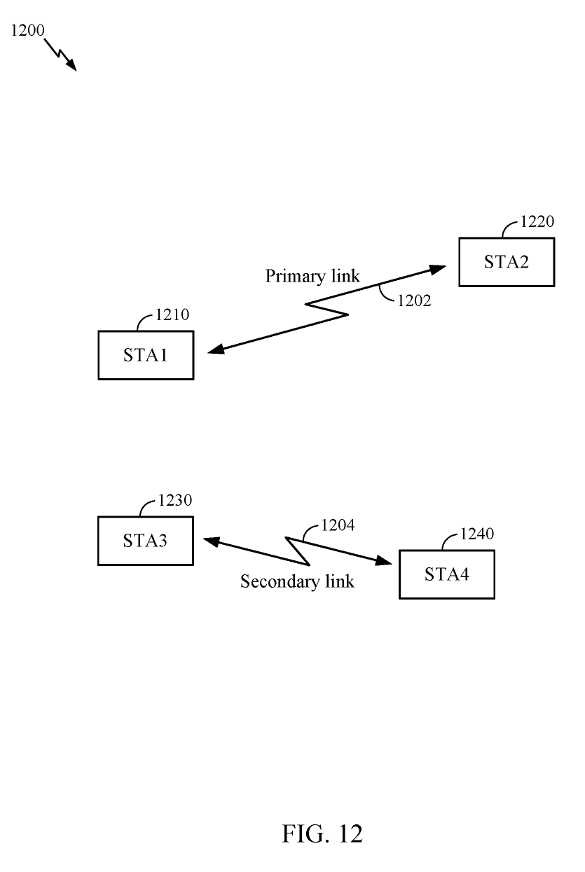

Operations 1100, begin at 1102, by a wireless node (530, 630, 730) obtaining at least one frame from a first wireless node (510, 610, 710) communicating with a second wireless node (520, 620, 720) on a medium via a first link. The wireless node (530, 630, 730) may obtain the at least one frame via an interface such as the transmit/receive interface 1230 of FIG. 12.

At 1104, the wireless node (530, 630, 730) estimates a potential level of interference, at the first wireless node (510, 610, 710) due to transmissions from the wireless node (530, 630, 730) to a third wireless node (540, 640, 740) on a second link on the medium, based on information in the at least one frame. In certain aspects, the information may include the ISF determined, for example, according to operations 1000 as described herein.

At 1106, the wireless node (530, 630, 730) reuses the medium for communicating with the third wireless node (540, 640, 740) via the second link if the potential level of interference estimated at 1104 is equal to or less than a threshold. The wireless node may reuse the medium by outputting frames to the third wireless node (540, 640, 740) via an interface such as the transmit/receive interface 1230 of FIG. 12.

At 1108, the wireless node (530, 630, 730) may, optionally, take one or more actions to reduce interference with or to the first link when outputting frames for transmission to the third wireless node via the second link. That is, the wireless node (530, 630, 730) may take actions to bring the estimated potential level of interference at the first wireless node equal to or less than the threshold, permitting the wireless node (530, 630, 730) to output frames to the third wireless node. In certain aspects, the wireless node (530, 630, 730) may reduce its transmit power, if the estimated potential level of interference exceeds the threshold, until the potential level of interference is less than or equal to the threshold. For example, the wireless node may perform transmit power control as further described herein in order to reduce the potential level of interference to be below the threshold. In certain aspects, after taking the one or more actions at 1108, the wireless node (530, 630, 730) may re-estimate the potential level interference according to 1104 and reuse the medium according to 1106 if the potential level of interference is less than or equal to the threshold.

FIG. 12 illustrates a block diagram of an example communication system 1200 implementing spatial reuse with the ISF determined, for example, according to operations 1000, in accordance with aspects of the present disclosure. The communication system 1200 includes a plurality of wireless nodes, such as a first wireless node 1210, a second wireless node 1220, a third wireless node 1230, and fourth wireless node 1240.

As shown, the first and second wireless nodes 1210, 1220 are communicating on a medium via a primary link 1202 (e.g., wireless nodes 1210, 1220 may be in a basic service set (BSS)). The third and fourth wireless nodes 1230, 1240 are depicted as neighboring nodes to the first and second wireless nodes 1210, 1220. The third and fourth wireless nodes 1230, 1240 may receive frames transmitted between the first and second wireless nodes 1210, 1220. The received frames may have the ISF determined according to operations 1000 and further described herein to facilitate spatial reuse. For instance, the third wireless node 1230 may estimate a potential level of interference, at the first wireless node 1210 due to transmissions from the third wireless node 1230 to the fourth wireless node 1240 on a second link 1204 (e.g., wireless nodes 1230, 1040 may be in an overlapping BSS), based at least in part on the ISF, as described herein with respect to operations 1100. The third wireless node 1230 may reuse the medium for communicating with the fourth wireless node 1240 via the second link 1204 if the estimated interference level is less than or equal to a threshold as described herein with respect to operations 1100.

In certain aspects, each wireless node of operations 1000 and 1100 may be programmed in advance with a default value of the ISF. This default ISF may provide the basis for the wireless node of operations 1000 to determine the ISF based on the various interference-related parameters as further described in herein. The default ISF may be a fixed value or calculated by the wireless node. For example, the ISF may be periodically calculated according to this expression:

ISF=Pₜₐ+(Gᵣₐ−Gₜₐ) Equation 5

where Pₜₐ is the transmit power of the originating/destination device (1210, 1220), and Gᵣₐ−Gₜₐ is the reciprocity factor of the originating/destination device (1210, 1220).

As previously mentioned in discussing FIG. 8, the wireless node of operations 1000 takes into account various interference-related parameters in determining the ISF. That is, the wireless node may determine the ISF based at least in part on at least one of an interference level encountered at the wireless node or an interference level allowed at the wireless node, which represent examples of interference-related parameters. For example, the wireless node (1210, 1220) may detect interference from the second link (1204) used by neighboring nodes (1230, 1240) to communicate or other sources of interference and adjust the default ISF according to the observed interference level. To reduce this encountered interference, the wireless node (1210, 1220) may decrease the default ISF as provided by the following expression:

ISF*=ISF−F₁ Equation 6

where ISF* may be the ISF value determined and output according to operations 1000, ISF is the default value of ISF preprogrammed or calculated by the wireless node or a previously determined value of ISF*, and F₁ is the reduction factor to decrease the default ISF. In certain aspects, the reduction factor F₁ may be determined as a portion of the default ISF before reduction or a portion of the interference observed at the wireless node. The wireless node of operations 1000 may gradually decrease the ISF until the interference level encountered at the wireless node is below a threshold interference.

The wireless node (1210, 1220) may also determine the ISF based on an interference level allowed at the wireless node. This allowed interference level may depend on at least one of a receiver sensitivity or link quality between the wireless and the destination/originating node. For example, suppose the wireless node (1210, 1220) has a high receive sensitivity, the default ISF value might be too high enabling significant interference from neighboring wireless nodes (1230, 1240). The wireless node (1210, 1220) may then decrease the default ISF based on its receiver sensitivity. As another example, suppose the wireless node (1210, 1220) is receiving a very strong signal from its pair (e.g., originating/destination device), then the default ISF value may be too low, meaning that increased interference from the neighboring nodes will not affect the link between the originating and destination device. The wireless node (1210, 1220) may then increase the default ISF based on the link quality with the originating/destination node (1210, 1220). In such situations, the wireless node (1210, 1220) may adjust the ISF based on an interference level allowed at the wireless node as given by this expression:

ISF*=ISF±F₂ Equation 7

where ISF* may be the ISF value determined and output according to operations 1000, ISF is the default value of ISF or a previously determined value of ISF*, F₂ is an adjustment factor used to increase or decrease the default ISF value according to operating conditions of the wireless node including the antenna/receive chain sensitivity and/or the link quality between the wireless node and the destination/originating node.

In certain aspects, the wireless node of operations 1000 may take into account the allowed interference and the encountered interference, together, in determining the ISF according to operations 1000. That is, the ISF may be determined according to the following expression:

ISF*=ISF−F₁±F₂ Equation 8

where F₁ and F₂ as defined by Equations 6 and 7 are both used to adjust the default ISF value or a previously calculated ISF*. In certain aspects, the wireless node of operations 1000 may determine that the default ISF value is acceptable based on the interference-related parameters as discussed herein and make no adjustments to the default ISF value. For example, F1 and/or F2 may be zero or a negligible level of interference.

The wireless node (1230, 1240) of operations 1100 may receive the ISF determined according to operations 1000 and estimate a potential level of interference at a neighboring wireless node (1210, 1220) as provided by the following expression:

Pᵣₐ=P_{rb}+P_{tb}+(G_{tb}−G_{rb})−ISF* Equation 9

where Pᵣₐ is the estimated potential level of interference at the neighboring wireless node (1210, 1220), P_{rb} is the power level of the frame received at the receiver input of the wireless node (1230, 1240), P_{tb} is the transmit power of the wireless node (1230, 1240), G_{tb}−G_{rb} is the reciprocity of the wireless node (1230, 1240), and ISF* is the interference sensitivity factor determined by the neighboring wireless node (1210, 1220) according to operations 1000, for example, based on Equations 6, 7, or 8 as described herein, and from which the wireless node (1230, 1240) may estimate the potential level of interference Pᵣₐ.

In certain aspects, the ISF may be related to a transmit power for transmitting the frame containing the ISF as described herein with respect to operations 1000. The ISF may be related to receive and transmit antenna gain reciprocity of the wireless node determining the ISF according to operations 1000. In certain aspects, the ISF may be related to a transmit power applied to an antenna of the wireless node and a receive and transmit antenna gain reciprocity of the wireless node determining the ISF according to operations 1000.

As previously mentioned with respect to operations 1100, the wireless node (1230, 1240) may take one or more actions to reduce the interference with or to the primary link (1202) when outputting frames for transmission to its respective pair (1230, 1240) via the secondary link (1204). For example, the wireless node (1230, 1240) may change its antenna configuration to reduce the interference with the primary link. In certain aspects, changing the antenna configuration may include changing a beamforming configuration or applying attenuation in a specific direction (e.g., null steering) to reduce the interference with the primary link. Changing the antenna configuration may also include changing or switching an antenna module or antenna array (e.g., antennas 270).

In certain aspects, any or all of the wireless nodes (1210, 1220, 1230, 1240) may perform transmit power control (TPC) to reduce the interference encountered by the neighboring nodes while communicating with its respective pair. A wireless node that performs TPC lowers its transmit power to such a level that the transmit power does not affect link throughput. Performing TPC may be one of the actions taken in operations 1100 to reduce interference with or to the primary link (1202).

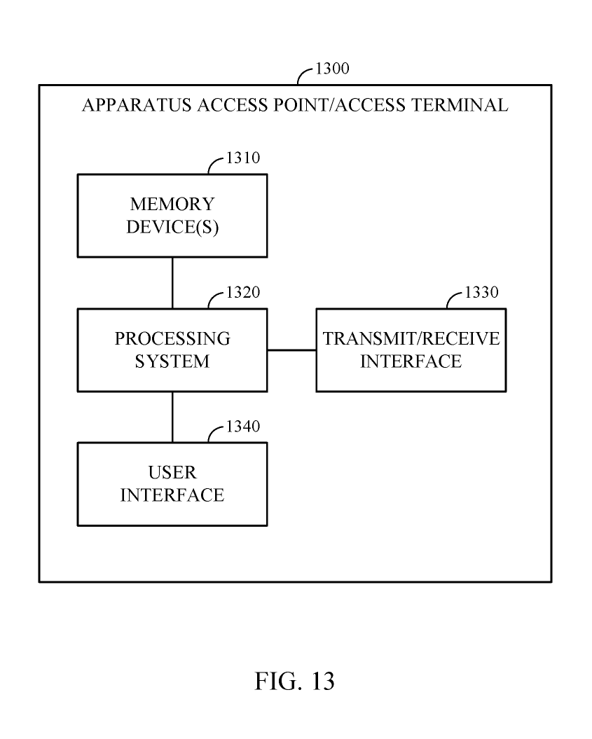

FIG. 13 illustrates an example device 1300 according to certain aspects of the present disclosure. The device 1300 may be configured to operate in an access point (e.g., access point 110) or an access terminal 120 (e.g., access terminal 120a) and to perform one or more of the operations described herein. The device 1300 includes a processing system 1320, and a memory device(s) 1310 coupled to the processing system 1320. In the example of the access point 110, the processing system 1320 may include one or more of the transmit data processor 220, the frame builder 222, the transmit processor 224, the controller 234, the receive data processor 244, and the receive processor 242. Still referring to the example of the access point 110, the memory device(s) 1310 may include one or more of the memory device(s) 236 and the data sink 246. Still referring to the example of the access point 110, the transmit/receive interface may include one or more of the bus interface, the transmit data processor 220, the transmit processor 224, the receive data processor 244, the receive processor 242, the transceivers 226a through 226n, and the antennas 230a through 230n.

In the example of the access terminal 120, the processing system 1320 may include one or more of the transmit data processor 260, the frame builder 262, the transmit processor 264, the controller 274, the receive data processor 284, and the receive processor 282. Still referring to the example of the access terminal 120, the memory device(s) 1310 may include one or more of the memory device(s) 276 and the data sink 286. Still referring to the example of the access terminal 120, the transmit/receive interface 1330 may include one or more of the bus interface, the transmit data processor 260, the transmit processor 264, the receive data processor 284, the receive processor 282, the transceivers 266a through 266n, and the antennas 270a through 270n.

The memory device(s) 1310 may store instructions that, when executed by the processing system 1320, cause the processing system 1320 to perform one or more of the operations described herein. Exemplary implementations of the processing system 1320 are provided below. The device 1300 also comprises transmit/receive circuitry, which may be referred to herein as a transmit/receive interface 1330, coupled (i.e., connectable) to the processing system 1320. The transmit/receive interface 1330 (e.g., interface bus) may be configured to interface the processing system 1320 to a radio frequency (RF) front end, or transmit/receive interface 1330, as discussed further below.

In certain aspects, the processing system 1320 may include one or more of the following: a transmit data processor (e.g., transmit data processor 220 or 260), a frame builder (e.g., frame builder 222 or 262), a transmit processor (e.g., transmit processor 224 or 264) and/or a controller (e.g., controller 234 or 274) for performing one or more of the operations described herein. In these aspects, the processing system 1320 may generate a frame and output the frame to the RF front end for wireless transmission (e.g., to an access point 110 or an access terminal 120).

In certain aspects, the processing system 1320 may include one or more of the following: a receive processor (e.g., receive processor 242 or 282), a receive data processor (e.g., receive data processor 244 or 284) and/or a controller (e.g., controller 234 and 274) for performing one or more of the operations described herein. In these aspects, the processing system 1320 may receive a frame from the RF front end and process the frame according to any one or more of the aspects discussed above.

In the case of an access terminal 120, the device 1300 may include a user interface 1340 coupled to the processing system 1320. The user interface 1340 may be configured to receive data from a user (e.g., via keypad, mouse, joystick, etc.) and provide the data to the processing system 1320. The user interface 1340 may also be configured to output data from the processing system 1320 to the user (e.g., via a display, speaker, etc.). In this case, the data may undergo additional processing before being output to the user. In the case of an access point 110, the user interface 1340 may be omitted.

In certain aspects, the processing system 1320 of FIG. 13 may be configured to perform processing functions for the device 1300, including processing signals received and/or to be transmitted by the device 1300 according to operations illustrated in one or more of FIGS. 8-11. In certain aspects, the computer-readable medium/memory 1310 of FIG. 13 is configured to store computer-executable instructions that when executed by the processing system 1320, cause the processing system 1320 to perform the operations illustrated in one or more of FIGS. 8-11, or other operations for performing the various techniques discussed herein. The transmit/receive interface 1330 may perform the transmitting/receiving operations, such as obtaining or outputting, illustrated in one or more of FIGS. 8-11.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for transmitting, means for outputting for transmission, or means for reusing a medium for communicating may comprise a transceiver (e.g., the transceiver 226) and/or an antenna(s) 230 of the access point 110 or the transceiver 266 and/or antenna(s) 270 of the user terminal 120 illustrated in FIG. 2. Means for receiving, means for obtaining, or means for reusing a medium for communicating may comprise a transceiver (e.g., the transceiver 226) and/or an antenna(s) 230 of the access point 110 or the transceiver 266 and/or antenna(s) 270 of the user terminal 120 illustrated in FIG. 2. Means for obtaining, means for generating, means for outputting, means for estimating, means for performing, means for taking one or more actions, or means for determining may comprise a processing system, which may include one or more processors, such as the RX data processor 244, the TX data processor 220, the TX processor 224, and/or the controller 234 of the access point 110 or the RX data processor 284, the TX data processor 260, the frame builder 262, the TX processor 264, and/or the controller 274 of the user terminal 120 illustrated in FIG. 2.

In some cases, rather than actually transmitting a frame, a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception. In some cases, an interface to output a frame for transmission and an interface for obtaining a frame may be integrated as a single interface.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and the bus interface. The bus interface may be used to connect a network adapter, among other things, to the processing system via the bus. The network adapter may be used to implement the signal processing functions of the physical (PHY) layer. In the case of an access terminal 120 (for example, see FIGS. 1, 2, and 13), a user interface (e.g., keypad, display, mouse, joystick, etc.) may also be connected to the bus interface. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by an access terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that an access terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
a processing system configured to:
determine an interference sensitivity factor (ISF) based at least in part on one or more interference-related parameters, and
generate at least one frame to be output for transmission to a first wireless node via a first link, the at least one frame including the ISF; and
an interface configured to output the at least one frame for transmission to the first wireless node via the first link.

2. The apparatus of claim 1, wherein the ISF is related to a transmit power applied to an antenna and a receive and transmit antenna gain reciprocity.

3. The apparatus of claim 1, wherein the interference-related parameters comprise at least one of an interference level allowed at the apparatus or an interference level encountered at the apparatus.

4. The apparatus of claim 3, wherein the interference level allowed at the apparatus depends on at least one of a sensitivity of a receiver connectable to the apparatus or a link quality between the apparatus and the first wireless node.

5. The apparatus of claim 1, wherein the at least one frame comprises at least one of a Request to Send (RTS) frame or a Clear to Send (CTS) frame, wherein the at least one frame further comprises at least one of a header or a control trailer (CT) carrying the ISF.

6. The apparatus of claim 1, wherein the processing system is further configured to perform transmit power control (TPC) when outputting frames for transmission to the first wireless node.

7. An apparatus for wireless communications, comprising:
an interface configured to obtain at least one frame from a first wireless node that is communicating with a second wireless node on a medium via a first link; and
a processing system configured to:
estimate a potential level of interference at the first wireless node, due to transmissions from the apparatus to a third wireless node on a second link on the medium, based on an interference sensitivity factor (ISF) in the at least one frame; and
reuse the medium for communicating with the third wireless node via the second link if the potential level of interference is equal to or less than a threshold.

8. The apparatus of claim 7, wherein the at least one frame comprises at least one of a Request to Send (RTS) frame or a Clear to Send (CTS) frame, wherein the at least one frame further comprises at least one of a header or a control trailer (CT) carrying the ISF.

9. The apparatus of claim 7, wherein the processing system is further configured to take one or more actions to reduce interference to the first link when outputting frames for transmission to the third wireless node via the second link.

10. The apparatus of claim 9, wherein the one or more actions comprise performing transmit power control (TPC).

11. The apparatus of claim 9, wherein the one or more actions comprise changing an antenna configuration.

12. The apparatus of claim 11, wherein changing the antenna configuration comprises changing a beamforming configuration.

13. The apparatus of claim 11, wherein changing the antenna configuration comprises applying attenuation in a specific direction.

14. The apparatus of claim 11, wherein changing the antenna configuration comprises at least one of changing or switching at least one of an antenna module or antenna array.

15. A method of wireless communications by an apparatus, comprising:
determining an interference sensitivity factor (ISF) based at least in part on one or more interference-related parameters;
generating at least one frame to be output for transmission to a first wireless node via a first link, said at least one frame including the ISF; and
outputting the at least one frame for transmission to the first wireless node via the first link.

16. The method of claim 15, wherein the ISF is related to a transmit power applied to an antenna and a receive and transmit antenna gain reciprocity.

17. The method of claim 15, wherein the interference-related parameters comprise at least one of an interference level allowed at the apparatus or an interference level encountered at the apparatus.

18. The method of claim 17, wherein the interference level allowed at the apparatus depends on at least one of a sensitivity of a receiver connectable to the apparatus or a link quality between the apparatus and the first wireless node.

19. The method of claim 15, wherein the at least one frame comprises at least one of a Request to Send (RTS) frame or a Clear to Send (CTS) frame, wherein the at least one frame further comprises at least one of a header or a control trailer (CT) carrying the ISF.

20. The method of claim 15, further comprising performing transmit power control (TPC) when outputting frames for transmission to the first wireless node.

21. A method of wireless communications by an apparatus, comprising:
obtaining at least one frame from a first wireless node that is communicating with a second wireless node on a medium via a first link;
estimating a potential level of interference at the first wireless node, due to transmissions from the apparatus to a third wireless node on a second link on the medium, based on an interference sensitivity factor (ISF) in the at least one frame; and
reusing the medium for communicating with the third wireless node via the second link if the potential level of interference is equal to or less than a threshold.

22. The method of claim 21, wherein the at least one frame comprises at least one of a Request to Send (RTS) frame or a Clear to Send (CTS) frame, wherein the at least one frame comprises at least one of a header or a control trailer (CT) carrying the ISF.

23. The method of claim 21, further comprising taking one or more actions to reduce interference to the first link when outputting frames for transmission to the third wireless node via the second link.

24. The method of claim 23, wherein the one or more actions comprise performing transmit power control (TPC).

25. The method of claim 23, wherein the one or more actions comprise changing an antenna configuration.

26. The method of claim 25, wherein changing the antenna configuration comprises changing a beamforming configuration.

27. The method of claim 25, wherein changing the antenna configuration comprises applying attenuation in a specific direction.

28. The method of claim 25, wherein changing the antenna configuration comprises at least one of changing or switching at least one of an antenna module or antenna array.
